(19) United States
(12) Patent Application Publication
(10) Pub. No.: US 2005/0219029 A1
(43) Pub. Date: Oct. 6, 2005

(54) Transformer

(75) Inventors: Osamu Watanabe, Hidaka-shi (JP); Junji Kondo, Kawagoe-shi (JP)

Correspondence Address: PITNEY HARDIN LLP, 7 TIMES SQUARE, NEW YORK, NY, 10036-7311, US

(73) Assignee: Tamura Corporation

(21) Appl. No.: 11/092,464

(22) Filed: Mar. 29, 2005

(30) Foreign Application Priority Data
Mar. 30, 2004 (JP) 2004-099806

(51) Int. Cl. H01F 27/30

(52) U.S. Cl. 336/208

(57) ABSTRACT

There is provided a transformer, which includes a coil bobbin having a wiring drum around which a primary coil and a secondary coil are wound, and terminal bases formed at end portions of the wiring drum. A plurality of terminals are formed on a surface of each terminal base. The transformer further includes insulative resin formed to cover an outer circumferential part of the coil bobbin excepting the plurality of terminals, and at least one core that is attached to the coil bobbin covered with the insulative resin. The wiring drum has a plurality of flanges including a first flange separating the primary and secondary coils, and second flanges formed at the end portions of the wiring drum.

### BACKGROUND OF THE INVENTION

The present invention relates to a transformer employed in, for example, a resonant switching circuit or an inverter power supply unit for backlight of an LCD (liquid crystal display) unit.

In general, wire-wound inverter transformers are configured to output high voltages at secondary terminals, while a low DC voltage is inputted thereto, so that the output of the secondary terminals are used as power supply for backlight.

If such a wire-wound inverter transformer is used as an inverter power supply unit, another power supply (i.e. a sub inverter power supply unit) is required to supply a DC voltage to the inverter power supply unit. That is, in this case, two power units are necessary.

To solve such a drawback that two power supply units are necessary, it is preferable to configure an inverter transformer to support a safety standard so that rectified AC line can be directly connected to primary terminals of the inverter transformer. That is because such a configuration of the inverter transformer eliminates the need for the sub inverter power supply unit, and thereby enhances the power efficiency.

FIG. 5A is a partial cross-sectional view of a conventional inverter transformer. In FIG. 5A, a bobbin 1B of the inverter transformer is illustrated. As shown in FIG. 5A, the bobbin 1B is configured as a multi-flange type bobbin. A primary coil 7B and a secondary coil 8B are separated by a flange 30a having a relatively small thickness of “a”.

A wiring drum 2B around which the first and second coils 7B and 8B are wound is also formed to have a relatively small thickness. That is, a relatively small distance “b” is formed between the primary coil 7B (secondary coil 8B) and a core 5B.

In order to support a safety standard, it is necessary to increase the thickness “a” of the flange 30a and the distance “b”. FIG. 5B is a partial cross-sectional view of a modified example with regard to the inverter transformer shown in FIG. 5A. In FIG. 5B, a bobbin 1C includes a flange 31a separating the primary coil 7B and the secondary coil 8B. The flange 31a has the thickness of “A” larger than the thickness “a” of the flange 30a. The bobbin 1C further includes a wiring drum 2C having a thick body so that the distance “B” larger than the distance “b” is secured between the primary coil 7B (secondary coil 8B) and the core 5B.

If the bobbin 1C configured as described above is employed in the transformer, the entire size of the transformer increases and thereby compactness of the transformer is lost. Therefore, the configuration of the modified inverter transformer shown in FIG. 5B is unfavorable with regard to downsizing and reduction of thickness of recent electronic devices.

FIG. 6 is a cross-sectional view of a transformer disclosed in Japanese Patent Provisional Publication No. HEI 5-121250. The transformer shown in FIG. 6 is configured to support a safety standard while avoiding the increase of the size. More specifically, the transformer shown in FIG. 6 is configured such that a coil bobbin 1D around which primary and secondary coils 7D and 8D are wound is sealed by molding to fill air clearance and space along the creepage distance as defined in a safety standard with resin 9D.

The thickness of a flange 32a of the bobbin 1C separating the primary and secondary coils 7D and 8D is equal to the other flanges 3D. The core 5D is fitted into the coil bobbin 1D. The resign 9D covers the entire circumferential part of the coil bobbin 1D and the core 5D excepting terminals 6D.

FIG. 7 is a perspective view of a transformer 44 which is another example of a conventional transformer configured to support a safety standard. The transformer 44 has a coil bobbin 1E around which first and second coils 7E and 8E are wound, and a terminal base 4E. A case 10E is attached to the coil bobbin 1E to cover the upper part of the coil bobbin 1E (i.e. the upper part of the terminal base 4E and the peripheral part of the first and second coils 7E and 8E).

### SUMMARY OF THE INVENTION

However, the configuration of the transformer shown in FIG. 6 has a drawback that the resin 9D stresses the core 5D when the resin 9D gets rigid because resin has a property that it contracts when it gets rigid. If the core 5D is stressed by the resin 9D, inductance of the core 5D may be affected and thereby performance of the transformer is deteriorated. Also, if the core 5D is stressed, a crack may be formed in the core 5D.

If the transformer shown in FIG. 6 is mass produced, a large amount of resin is necessary. Therefore, manufacturing cost of the mass production increases.

In the case of the transformer shown in FIG. 7, a process for producing the case 10E by molding and for attaching the case 10E to the coil bobbin 1E is necessary. Therefore, the configuration shown in FIG. 7 is unfavorable with regard to cost and productivity.

The present invention is advantageous in that it provides a molded type transformer capable of preventing deterioration of performance by reducing the amount of resin, and thereby suppressing the increase of the size and cost of the transformer.

According to an aspect of the invention, there is provided a transformer, which is provided with a coil bobbin having a wiring drum around which a primary coil and a secondary coil are wound, and terminal bases formed at end portions of the wiring drum. A plurality of terminals are formed on a surface of each terminal base. The transformer is further provided with insulative resin formed to cover an outer circumferential part of the coil bobbin excepting the plurality of terminals, and at least one core that is attached to the coil bobbin covered with the insulative resin. The wiring drum has a plurality of flanges including a first flange separating the primary and secondary coils, and second flanges formed at the end portions of the wiring drum.

Since the coil bobbin is covered with resin, the insulation between the primary and secondary coils can be enhanced. In addition, since the core is not covered with resin, the core is not stressed by the resin and therefore inductance is not deteriorated. The amount of resin required for mass producing transformers can be reduced since the core is not covered with resin, by which downsizing and cost reduction of the transformer are attained.

Optionally, at least one groove may be formed in the first flange separating the primary and secondary coils so as to extend a creepage distance between the primary and secondary coils.

Still optionally, the terminal bases may be formed to extend outward from lower portions of the second flanges.

Still optionally, the at least one core may have a form of a letter E and has a mid foot and outer feet. In this case, the at least one core may be attached to the coil bobbin such that the mid foot is inserted into a hollow portion of the wiring drum and the outer feet are situated outside the wiring drum.

According to another aspect of the invention, there is provided a transformer, which is provided with a hollow body around which a primary coil and a secondary coil are wound, a plurality of terminals formed at end portions of the hollow body, and at least one core attached to the hollow body. The hollow body has a plurality of separating means including a first separating means for separating the primary and secondary coils, and second separating means formed at the end portions of the hollow body. Insulative resin is formed to cover an outer circumferential part of the hollow body excepting the plurality of terminals so that the at least one core is not covered with the insulative resin.

Since the hollow body is covered with resin, the insulation between the primary and secondary coils can be enhanced. In addition, since the core is not covered with resin, the core is not stressed by the resin and therefore inductance is not deteriorated. The amount of resin required for mass producing transformers can be reduced since the core is not covered with resin, by which downsizing and cost reduction of the transformer are attained.

Optionally, at least one groove may be formed in the first separating means separating the primary and secondary coils so as to extend a creepage distance between the primary and secondary coils.

Still optionally, the transformer may include terminal bases formed at the end portions of the hollow body. In this case, the plurality of terminals are formed on each of the terminal bases.

Still optionally, the at least one core may have a form of a letter E and has a mid foot and outer feet, and the at least one core may be attached to the hollow body such that the mid foot is inserted into a hollow portion of the hollow body and the outer feet are situated outside the wiring drum.

According to another aspect of the invention, there is provided a manufacturing method of a transformer. The method includes providing a coil bobbin having a wiring drum around which a primary coil and a secondary coil are wound, and terminal bases which are formed at end portions of the wiring drum and are provided with a plurality of terminals, covering an outer circumferential part of the coil bobbin excepting the plurality of terminals with insulative resin, and attaching at least one core to the coil bobbin covered with the insulative resin.

Since the coil bobbin is covered with resin, the insulation between the primary and secondary coils can be enhanced. In addition, since the core is not covered with resin, the core is not stressed by the resin and therefore inductance is not deteriorated. The amount of resin required for mass producing transformers can be reduced since the core is not covered with resin, by which downsizing and cost reduction of the transformer are attained.

Optionally, at least one groove may be formed in the first flange separating the primary and secondary coils so as to extend a creepage distance between the primary and secondary coils. In this case, the at least one groove is filled with the insulative resin when the circumferential part of the coil bobbin is covered with the insulative resin.

Still optionally, the at least one core may have a form of a letter E and has a mid foot and outer feet; and the at least one core may be attached to the coil bobbin such that the mid foot is inserted into a hollow portion of the wiring drum and the outer feet are situated outside the wiring drum.

### BRIEF DESCRIPTION OF THE ACCOMPANYING DRAWINGS

FIG. 1 is a perspective view of a coil bobbin and cores as parts of a transformer according to a first embodiment;

FIG. 2 is a perspective view of the coil bobbin illustrating a situation in which the coil bobbin is covered with rein;

FIG. 3 is a perspective view of the transformer according to the first embodiment;

FIG. 4A is a cross-sectional view of a transformer according to a second embodiment;

FIG. 4B is a enlarged view of a substantial part of the transformer shown in FIG. 4A;

FIG. 5A is a partial cross-sectional view of a conventional inverter transformer;

FIG. 5B is a partial cross-sectional view of a modified example of the conventional inverter transformer shown in FIG. 5A;

FIG. 6 is a cross-sectional view of another example of a conventional transformer;

FIG. 7 is shows another example of a conventional transformer; and

FIG. 8 is a flowchart of a manufacturing process of the transformer according to the first embodiment.

### DETAILED DESCRIPTION OF THE EMBODIMENTS

Hereafter, embodiments according to the invention will be described with reference to the accompanying drawings.

### First Embodiment

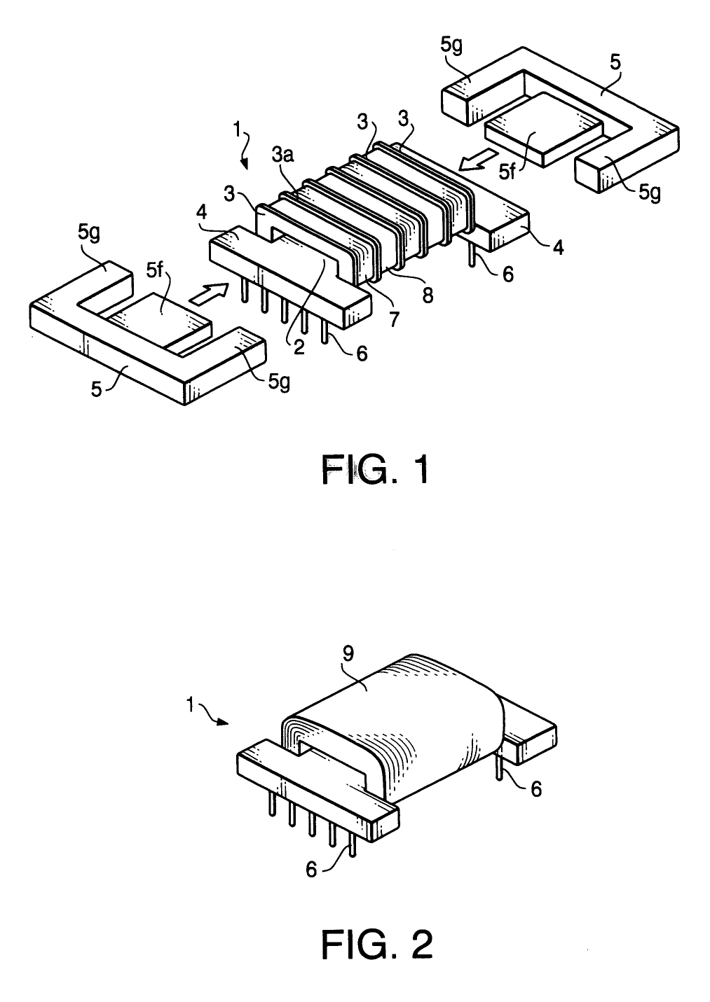

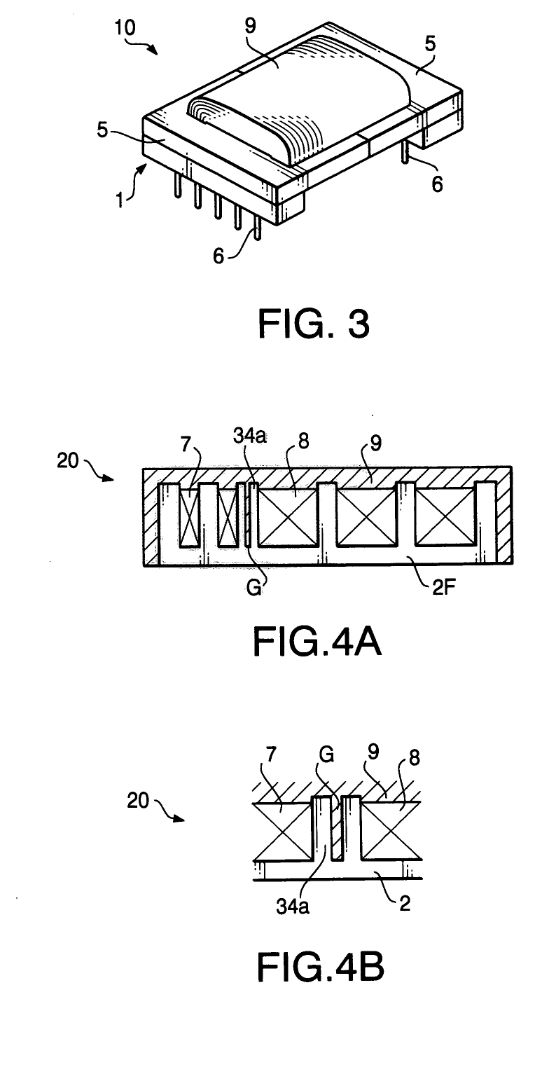

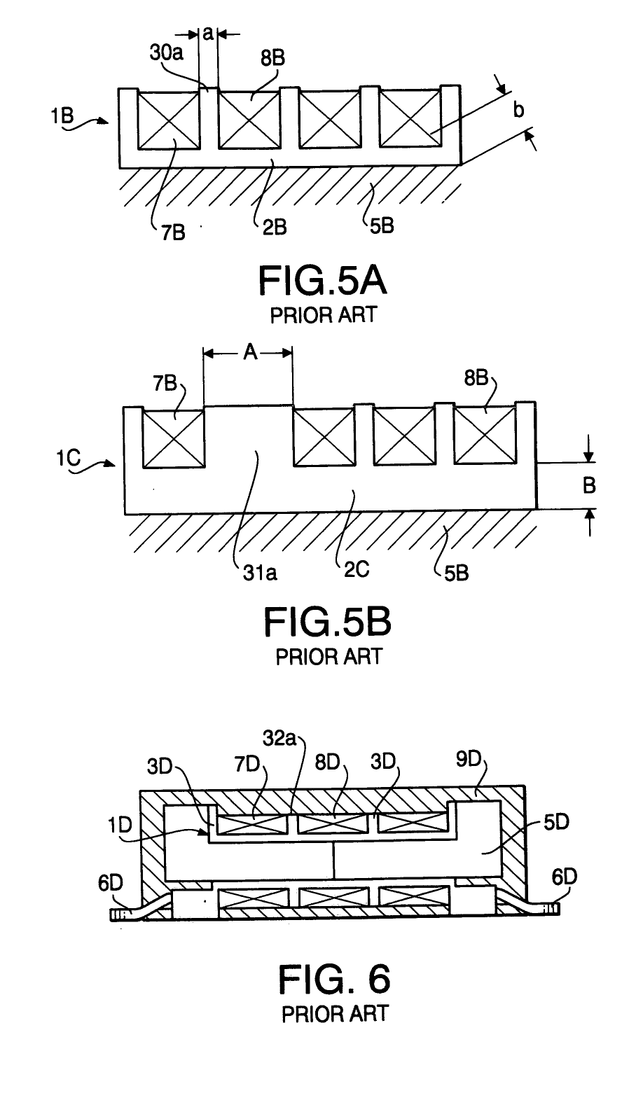

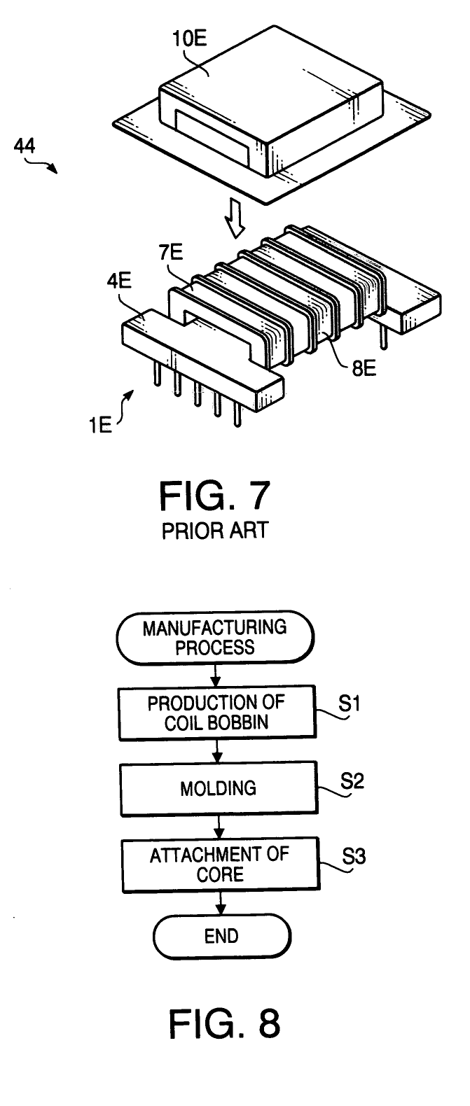

FIG. 1 is a perspective view of a coil bobbin 1 and cores 5 and 5 as parts of a transformer 10 (see FIG. 3) according to a first embodiment of the present invention. The coil bobbin 1 includes a tube-type wiring drum 2 provided with a plurality of flanges 3 and 3a arranged at certain intervals along an elongated direction of the wiring drum 2. That is, the coil bobbin 1 is a multi-flange type bobbin. The flange 3a separates a primary coil 7 and a secondary coil 8.

On a lower side of the winding drum 2, terminal bases 4 and 4 are formed at end portions of the winding drum 2 in the elongated direction. The cores 5 and 5 are placed on upper surfaces of the terminal bases 4 and 4, respectively. Each core 5 has a form of a letter “E”. The cores 5 and 5 are located face-to-face, and a mid foot 5a of each core 5 is inserted into the inside of the wiring drum 2. Outer feet 5g of the cores 5 and 5 are located at the outside of the wiring drum 2.

A plurality of terminals 6 are formed on the lower surface of the terminal bases 4 and 4. Around the outer circumference part of the wiring drum 2, the primary coil 7 and secondary coil 8 are wound at predetermined portions, and leader lines of the primary and secondary coils 7 and 8 are hooked to root parts of the terminals 6 and are fixed to the terminals 6 by soldering.

Before the cores 5 and 5 are inserted into the wiring drum 2, the coil bobbin 1 is covered with insulative resin 9 as shown in FIG. 2. FIG. 2 is a perspective view of the coil bobbin 1 illustrating a situation in which the coil bobbin 1 is covered with the rein 9. As shown in FIG. 2, the outer circumferential part of the coil bobbin 1 excepting the terminals 6 is sealed with the resin 9 such as epoxy resin. The resin 9 may be formed by molding.

FIG. 8 is a flowchart of a manufacturing process of the transformer 10 according to the embodiment. As shown in FIG. 8, the resin 9 is formed (step S2), after the coil bobbin 1 is produced as mentioned above (step S1). For example, at step S2, the resin 9 is formed by accommodating the coil bobbin 1 into a case (not shown) first, and then infusing the case with resin with keeping a hollow part of the wiring drum 2 from being filled with the resin.

Then, the transformer 10 is produced by attaching the cores 5 and 5 to the wiring drum 2 on the terminal bases 4 and 4 after the resin gets rigid (step S3). FIG. 3 is a perspective view of the transformer 10 produced as above.

According to the first embodiment, since the coil bobbin 1 is covered with resin 9, the insulation between the primary and secondary coils 7 and 8 can be enhanced. In addition, since the cores 5 and 5 are not covered with resin, the cores 5 and 5 are not stressed by the resin 9 and therefore inductance is not deteriorated. The amount of resin required for mass producing transformers can be reduced since the cores 5 and 5 are not covered with resin, by which downsizing and cost reduction of a transformer are attained.

### Second Embodiment

FIG. 4A is a cross-sectional view of a transformer 20 according to a second embodiment of the invention. The transformer 20 has substantially the same configuration as that of the transformer 10 of the first embodiment. Therefore, to components which are the same as those of the transformer 10, the same reference numbers are assigned, and explanations thereof will not be repeated. FIG. 4B is an enlarged view of the transformer 20 illustrating in detail a substantial part of the transformer 20.

A wiring drum 2F has a flange 34a separating the primary coil 7 and secondary coil 8. The feature of the transformer 20 is that the flange 34a is provided with a groove G. As shown in FIGS. 4A and 4B, the groove G is formed at a central portion of the flange 34a in a direction of the thickness of the flange 34a so as to increase the creepage distance between the primary and secondary coils 7 and 8, and to assure the insulation between the primary and secondary coils 7 and 8 by filling the groove G with resin 9 by a molding process. As shown in FIGS. 4A and 4B, the groove G is formed to extend outward from a wiring drum side.

According to the second embodiment, insulation between the primary and secondary coils 7 and 8 is further enhanced. Therefore, deterioration of performance is prevented securely.

Although the present invention has been described in considerable detail with reference to certain preferred embodiments thereof, other embodiments are possible.

For example, two or more grooves may be formed in the flange 34a to further increase the creepage distance, although a single grove G is formed in the flange 34a in the second embodiment.

The present disclosure relates to the subject matter contained in Japanese Patent Application No. 2004-099806, filed on Mar. 30, 2004, which is expressly incorporated herein by reference in its entirety.

1. A transformer, comprising:
a coil bobbin having a wiring drum around which a primary coil and a secondary coil are wound, and terminal bases formed at end portions of the wiring drum, a plurality of terminals being formed on a surface of each terminal base;
insulative resin formed to cover an outer circumferential part of the coil bobbin excepting the plurality of terminals; and
at least one core that is attached to the coil bobbin covered with the insulative resin,
wherein the wiring drum has a plurality of flanges including a first flange separating the primary and secondary coils, and second flanges formed at the end portions of the wiring drum.

2. The transformer according to claim 1, wherein at least one groove is formed in the first flange separating the primary and secondary coils so as to extend a creepage distance between the primary and secondary coils.

3. The transformer according to claim 1, wherein the terminal bases are formed to extend outward from lower portions of the second flanges.

4. The transformer according to claim 1, wherein:
the at least one core has a form of a letter E and has a mid foot and outer feet; and
the at least one core is attached to the coil bobbin such that the mid foot is inserted into a hollow portion of the wiring drum and the outer feet are situated outside the wiring drum.

5. A transformer, comprising:
a hollow body around which a primary coil and a secondary coil are wound;
a plurality of terminals formed at end portions of the hollow body; and
at least one core attached to the hollow body,
wherein the hollow body has a plurality of separating means including a first separating means for separating the primary and secondary coils, and second separating means formed at the end portions of the hollow body, and
wherein insulative resin is formed to cover an outer circumferential part of the hollow body excepting the plurality of terminals so that the at least one core is not covered with the insulative resin.

6. The transformer according to claim 5, wherein at least one groove is formed in the first separating means separating the primary and secondary coils so as to extend a creepage distance between the primary and secondary coils.

7. The transformer according to claim 5, further comprising terminal bases formed at the end portions of the hollow body,
wherein the plurality of terminals are formed on each of the terminal bases.

8. The transformer according to claim 5, wherein:
the at least one core has a form of a letter E and has a mid foot and outer feet; and
the at least one core is attached to the hollow body such that the mid foot is inserted into a hollow portion of the hollow body and the outer feet are situated outside the wiring drum.

9. A manufacturing method of a transformer, comprising:
providing a coil bobbin having a wiring drum around which a primary coil and a secondary coil are wound, and terminal bases which are formed at end portions of the wiring drum and are provided with a plurality of terminals;
covering an outer circumferential part of the coil bobbin excepting the plurality of terminals with insulative resin; and
attaching at least one core to the coil bobbin covered with the insulative resin.

10. The method according to claim 9, wherein:
at least one groove is formed in the first flange separating the primary and secondary coils so as to extend a creepage distance between the primary and secondary coils; and
the at least one groove is filled with the insulative resin when the circumferential part of the coil bobbin is covered with the insulative resin.

11. The method according to claim 9, wherein:
the at least one core has a form of a letter E and has a mid foot and outer feet; and
the at least one core is attached to the coil bobbin such that the mid foot is inserted into a hollow portion of the wiring drum and the outer feet are situated outside the wiring drum.
